(19) United States
(12) Patent Application Publication
(10) Pub. No.: US 2014/0149025 A1
(43) Pub. Date: May 29, 2014

(54) VEHICLE REMOTE START METHOD AND SYSTEM

(71) Applicant: DEI Headquarters, Inc., Vista, CA (US)

(72) Inventor: Peter Fazi, Lachine (CA)

(73) Assignee: DEI HEADQUARTERS, INC., Vista, CA (US)

(21) Appl. No.: 14/087,951

(22) Filed: Nov. 22, 2013

Related U.S. Application Data
(60) Provisional application No. 61/730,444, filed on Nov. 27, 2012.

(51) Int. Cl. F02N 11/08

(52) U.S. Cl. CPC F02N 11/08
USPC 701/113

(57) ABSTRACT

An aftermarket remote vehicle control system that utilizes a factory remote door lock/unlock fob to remotely control devices on the vehicle and to control the vehicle security features and locking functions. The system is in communication with a vehicle data bus system to determine data signals transmitted on the vehicle data bus associated with RF signals received from a factory fob. The system emulates a factory programmed signals on a vehicle data bus when a predetermined set of data command signals are received.

### CROSS-REFERENCE TO RELATED APPLICATIONS

This application claims the benefit of and is a continuation of U.S. Provisional Patent Application Ser. No. 61/702,728 filed Sep. 18, 2013

### BACKGROUND OF THE INVENTION

The present invention is in the technical field of vehicle remote start systems. More particularly, the present invention is in the technical field of remote start systems capable of use with vehicles having a data bus network for control of vehicle device functions.

Remote vehicle starters systems are known and are desirable in that they allow for warming a vehicle when the environment is cold and cooling the vehicle when the environment is hot without the driver entering the vehicle. With most new vehicles, a manufacturer provides a remote door lock/unlock system. The factory installed remote door lock/unlock system is generally comprised of a hand held transmitter that provides a signal to a receiver mounted in the vehicle. However, these systems are limited in that they do not transmit a start signal for starting the vehicle motor. To enjoy the benefit of a remote starter, the car must be fitted with an aftermarket remote start system.

Traditional aftermarket vehicle remote start systems generally include a receiver module mounted within the vehicle having a closed analog circuit hard wired to vehicle ignition switches, and a hand held remote radio frequency transmitter fob to transmit a local coded RF signal to the receiver module. When an authorized signal transmitted from the hand held remote fob is received by the module in the vehicle an electric pulse is transmitted from the module to the vehicle ignition system to start the vehicle's motor. The hand held remote transmitter is programmed using an unique identification code to a particular receiver so that only an authorized RF signal received by the module will start the vehicle.

One limitation with installing an aftermarket remote start system is that the driver is required to carry two remote fobs or hard wire connect the aftermarket system to the factory door lock/unlock motors, which requires significant addition installation time and additional hardware components. This allows the aftermarket fob and the factory fob to both control the door locks, with the OEM fob being set aside, un-carried and unused by the driver.

As vehicle technology has evolved to use digital vehicle data bus systems to control vehicle components, aftermarket manufacturers have developed products, generally referred to as interface modules, to read from and send data messages to the vehicle data bus. The interface module converts analog signals generated by aftermarket systems to digital signals that can be utilized to control devices in the vehicle. The interface module also reads digital signals transmitted on the bus and converts them to analog electrical pulses to operate the aftermarket unit. The interface module connection to the data bus has generally been made through connection through the OBDII port or by hard wiring a data line to the data bus network.

Through use of an data bus interface module it was no longer necessary for aftermarket manufacturers to hard wire aftermarket remote start systems to vehicle ignition systems. The aftermarket hand held remote fob transmits an analog RF command signal to the aftermarket remote start unit installed in the vehicle, which in turn uses the interface module to convert the received analog engine signal to a digital start engine data command that is transmitted to the data bus. The micro controller on the bus associated with the vehicle starter recognizes the digital start command and starts the vehicle.

However, when the OEM vehicle maker installs at the factory a remote lock/unlock system without a remote starter the purchaser of the vehicle is still required to have an aftermarket remote start system installed. This case still requires the driver to use two remote fobs, one for the remote start and one for the factory door locks, or alternatively, the aftermarket system is required to have additional components installed to control the door locks, adding cost to the installed aftermarket product while the factory remote was again set aside.

Accordingly, there is a need in the industry for an aftermarket remote vehicle starting system that is easily configurable to allow for the use of a factory installed door locking and unlocking system remote controller to remotely start and stop the vehicle engine.

### BRIEF SUMMARY OF THE INVENTION

The objects of this invention is to provide novel solutions to overcome the limitation described relating to current vehicle remote start systems.

It is an object of the current invention to provide for an aftermarket remote start system that utilizes a factory remote door lock/unlock fob to remotely start the vehicle and to control the vehicle security features and locking systems.

It is a further object of the present invention to provide an aftermarket remote start system that is in communication with a vehicle data bus system to determine data signals transmitted on the vehicle data bus associated with RF signals received from a factory programmed remote door lock system hand held fob.

It is a further object of the present invention to provide an aftermarket remote start system that emulates a factory programmed engine start signal on a vehicle data bus when a predetermined set of door lock signals are received.

It is yet another object of the present invention to provide an aftermarket remote start system that allow remote engine start using a factory door lock/unlock system remote while maintaining all of the intended door lock/unlock functioning.

### BRIEF DESCRIPTION OF THE DRAWING

FIG. 1 is a block diagram demonstrating one embodiment of the remote start system of the present invention.

FIG. 2 is a flow chart demonstrating logic used by the machine executable code for monitoring the vehicle data bus.

FIG. 3 is a flow chart demonstrates the logic used to begin the start engine command initiation sequence of one embodiment of the current invention.

### DESCRIPTION OF THE INVENTION

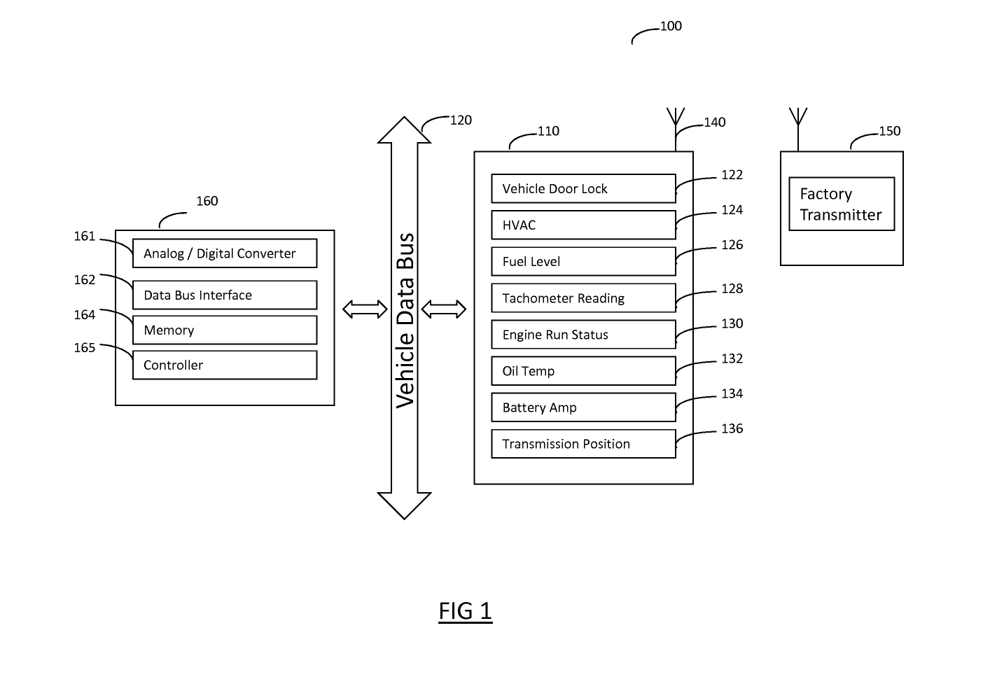

Referring now to the drawings. FIG. 1 shows a block diagram of one embodiment of the current novel remote automobile starter system 100. The present invention enables control, using the original factory programmed remote control fob, of an aftermarket remote starter or security system that has been installed in a vehicle having a data bus system and remote door lock system. The system 100 as described in the disclosed embodiment includes a vehicle 110 having data bus network 120 in electronic communication with various vehicle devices associated with starting of an automobile. As disclosed, these devices include a variety of sensors associated with said devices to monitor the status or condition of device. These devices may include vehicle door locks 122, the vehicle HVAC system 124, fuel level 126, tachometer 128, engine run status 130, oil temp 132, battery amperage 134 and transmission position. It will be appreciated by on skilled in the art that any device may be associated with the vehicle data bus and in communication on the data bus.

The system 100 also includes an RF receiver 140 associated with the vehicle 110 for receiving RF signals transmitted from a remote transmitter 150. The remote transmitter 150 has been paired to the receiver 140 by programmed at the factory during the manufacturing of the vehicle 110. This pairing is intended to prevent access to the vehicle 110 by a remote transmitter unless it has been properly paired.

An aftermarket remote start module 160 is installed in the vehicle 110 and is in digital communication with the vehicle 110 through a data bus interface 162, which is interfaced through the vehicle data bus network 120. The interface can be achieved through a standard connector or by hard wiring the module 160 to the vehicle data bus 120.

The remote start module 160 is further comprised of a micro controller 165, a multi-channel analog-to-digital converter 161, and a memory 164. The module 160 is further comprised of a power management circuit (not shown) and the system components are powered by connection of the module with the vehicle's 110 power circuit and ground. The module memory 164 stores a plurality of OEM data command signals. The command signals can be programmed into memory at the aftermarket manufacturer or are flashed to memory connecting to the internet or by using any other hand held electronic programmer, cell phone or computer. It is also contemplated that the command signal can be learned from monitoring data traffic on the vehicle data bus 120. For example, the installer may use the factory remote 150 to active a normal command function of the vehicle 110 such as lock or unlock the door. As the command code is pass on the vehicle data bus 120, the module 160 monitors the data traffic and copies the command code into memory 164 and associates the code with the command function. It will be recognized by one skilled in the art that any number of command codes can be captured by this method, associated with command function and stored in memory 164.

The analog digital converter 161 allow for translation of pulsed electrical analog signals generated by the aftermarket remote start, security system or other analog device to be converted into digital command signals recognized by the vehicle data bus network 120. It also allows for conversion of digital command codes to analog signals. Generally, the converter is not required for execution of the current invention.

Using the factory transmitter 150 to control an aftermarket remote starter or security system is accomplished by the disclosed embodiment of the invention by installing the remote start module 160 in a vehicle 110 having a data bus network 120 and remote door lock system 122. The system 100 executes the inventive method using computer readable code embedded in the module micro-controller 165 of the remote start module 160. The module 160 is pre-programmed with data command code for the functions of the vehicle in which it is installed. For example, the installer of the module will know that the module will be installed in a particular make, model and year of a vehicle. The installer can go to a website, use a hand held programmer, smart phone or similar data sharing device and select the data command function codes associated with the proper make, model and year of the vehicle and upload the command function codes into the memory 164 of the module 160.

In normal operations, if the a vehicle driver depresses an unlock door switch (not shown) on the factory transmitter 150, an RF signal is transmitted and received by the vehicle receiver 140, which then triggers an unlock door command signal to be transmitted on the vehicle data bus 120. Similarly, if a lock door switch is depressed a lock command code is transmitted on the data bus 120. If a door lock has been unlocked after receiving an unlock command signal, subsequent receipt of additional unlock command signals will have no effect. The lock is already in the unlock position. The same holds true for the lock position. If the lock is already in the lock position, receipt of a lock command signal will have no effect.

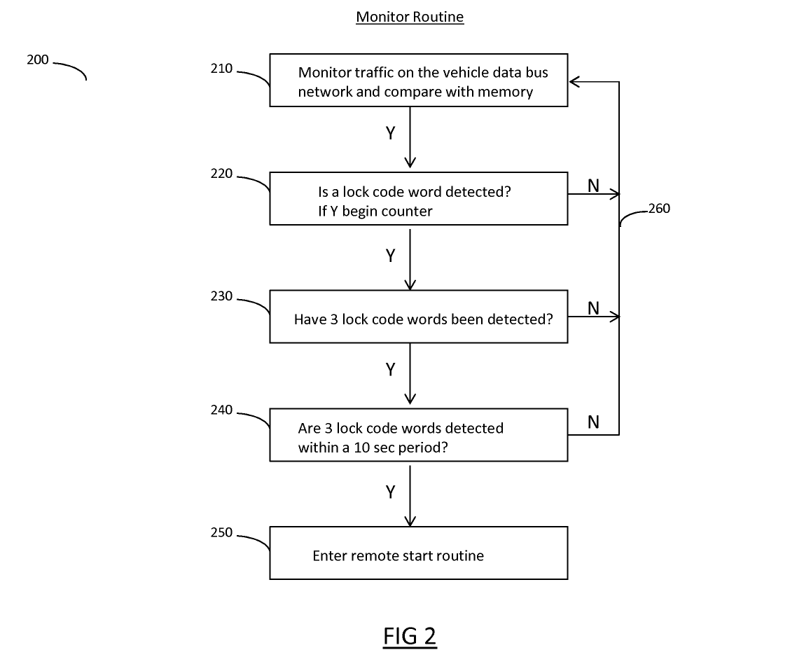

The module 160 is capable of monitoring the encoded data command codes as they are being communicated on the vehicle data bus 120 during normal operation. As described further with respect to FIG. 2, the module 160 includes software embedded in the controller 163 to provide instructions for monitoring the digital command signals being communicated on the data bus 120 by all data bus attached devices. FIG. 2 shows one embodiment of the logic that could be used to execute monitoring of command words as they are communicated on the vehicle data bus 200. Now with reference to FIGS. 1 and 2, the module 160 will monitor 210 all command words as they are transmitted on the vehicle data bus and compare the command signals being communicated with those pre-programmed codes stored in memory 164. If the factory remote 150 is used in normal operation to lock a vehicle door 122 a single or short burst of lock door command signals will be generated on the vehicle data bus 120. In this scenario the logic simply continue to monitor for additional traffic 260. However, the software will begin a counter to count the number of lock door command signals received 220. If the modules 160 detects three lock door signals 230 within a ten second period 240, the software will enter a remote start routine 250. It will be appreciated by one skilled in the art that any sequence or timing of factory remote switch depressions can be used to trigger the remote start routine. For example, in an alternative embodiment the trigger may be a sequence of switch depressions for lock, unlock, lock, unlock, lock, unlock, lock. Any desired sequence can be programmed into the module 160 by the user by entering a programming mode which allows the installer or user to input a sequence that is desired for personal or security purposes. When recognized by the module 160, the system will enter a remote start routine.

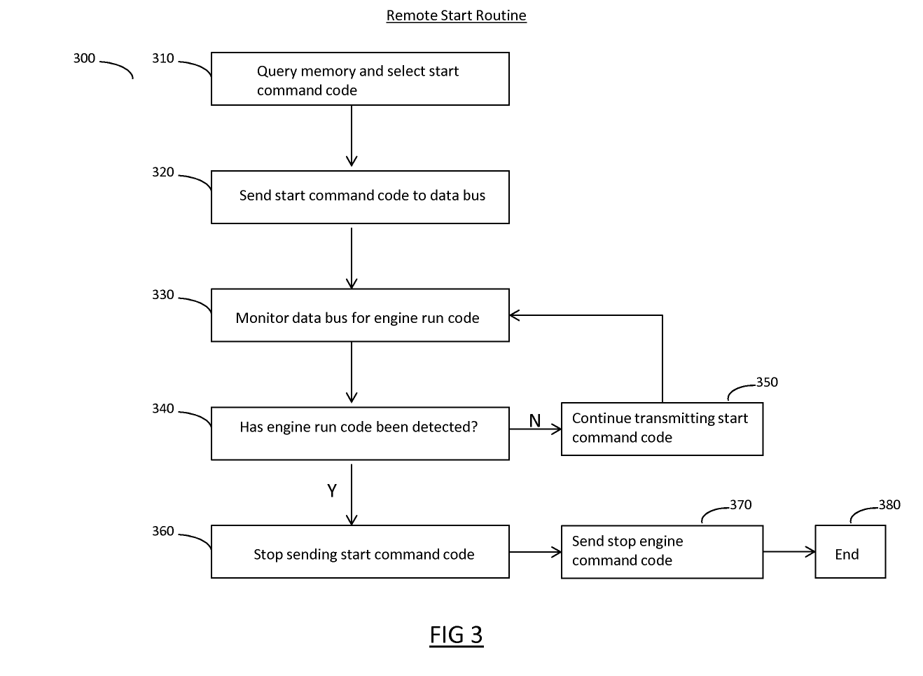

Now with reference to FIGS. 1 and 3, upon receipt by the module 160 of the proper sequence of coded command signals from the vehicle data bus 120, the software enters a start engine sub-routine that issues a start engine digital command signal to the data bus or a stop engine sub-routine that issues a stop engine digital command.

If the proper sequence is received within a predetermined time period, the routine queries the memory 164 and selects the command code for engine start 310. Upon selection from memory 164 of the start engine data command by the controller 165 the command is sent 320 to the vehicle data bus 120 for receipt by the body control module of the vehicle to initiate engine start. The controller 165 continues to monitor the data bus for codes indicating the engine is in run mode 330. If an engine run code is not received the controller continues to transmit a start engine command 350. If the engine run code has been received the controller ceases sending the start engine command code 360 and the routine is ended 380. Adversely, if the engine is running a stop engine subroutine is initiated. Devices on the vehicles data bus network recognize the start engine data word command generated by the module as a factory programmed data command and the OEM starter starts the vehicle.

It will be recognized by one skilled in the art that the start engine data command signal can be programmed into the software code and sent directly to the data bus. However, it is preferable to provide a system that allows selection of the make, model and year of the vehicle and store the corresponding start engine data command signal in memory. This provides a convenient method to provide for a large variety of command codes in a standard module for installation in a plurality of vehicles, each a different make, model or year and having a different digital code for the start engine data command signal. A single command signal digital sequence programmed into the executable code will not be sufficient to function in each vehicle type. By selecting from memory, the module memory can be programmed with start engine command signals for the specific vehicle in which the module is installed.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. An aftermarket remote control system for a vehicle having a data bus network and door lock system with a remote transmitter for locking and unlocking the vehicle doors, the door lock system communicating a set of first data signals representing door lock and unlock through the data bus network, the remote starter system comprising:
a remote control module installed in the vehicle comprising:
a memory configured to store the set of first data signals;
a data bus interface configured to provide communication of data signals between the remote control module and the data bus network;
a controller, wherein the controller is configured to monitor data signals transmitted on the data bus network, compare data signals transmitted on the data bus network with the sets of first data signals stored in memory, and if the data signals transmitted on the data bus network match a pre-determined sequence of the first data signals, send a second data signal to the data bus network for control of a device associated with the data bus network.

2. The aftermarket remote control system of claim 1, wherein the transmission of the predetermined sequence of the first data signals is initiated by the remote transmitter.

3. The aftermarket remote control system of claim 1, wherein the second data signal is associated with start of the vehicle engine.

4. The aftermarket remote control system of claim 1, within the predetermined sequence of first data signals is communicated on the data bus network within a pre-determined time period.

5. The aftermarket remote control system of claim 1, wherein the set of first data signals is associated with a sequence of lock or unlock commands transmitted from the remote transmitter.

6. The aftermarket remote control system of claim 5, wherein the set of first data signals is a sequence of three lock commands transmitted from the remote transmitter.

7. A method of remotely controlling a vehicle having a data bus network and door lock system with a remote transmitter for locking and unlocking the vehicle doors, the door lock system communicating a set of first data signals representing door lock and unlock through the data bus network, the method comprising the steps of:
Installing a remote starter module in the vehicle, the module comprising:
a memory configured to store the set of first data signals;
a data bus interface configured to provide communication of data signals between the remote starter module and the data bus network; and
monitoring data signals transmitted on the data bus network;
compare data signals transmitted on the data bus network with the sets of first data signals stored in memory; and
if the data signals transmitted on the data bus network match a pre-determined sequence of the first data signals sending a second data signal to the data bus network for control of a device associated with the data bus network.

8. The method of claim 7, wherein the transmission of the predetermined sequence of the first data signals is initiated by the remote transmitter.

9. The method of claim 7, wherein the second data signal is associated with start of the vehicle engine.

10. The method of claim 7, wherein the predetermined sequence of first data signals is communicated on the data bus network within a pre-determined time period.

11. The method of claim 7, wherein the set of first data signals is associated with a sequence of lock or unlock commands transmitted from the remote transmitter.

12. The method of claim 7, wherein the set of first data signals is a sequence of three lock commands transmitted from the remote transmitter.
